(19) United States
(12) Patent Application Publication
(10) Pub. No.: US 2022/0024202 A1
(43) Pub. Date: Jan. 27, 2022

(54) PRINTHEAD CONTROLLERS

(71) Applicant: HEWLETT-PACKARD DEVELOPMENT COMPANY, L.P., Spring, TX (US)

(72) Inventors: Antonio Gracia Verdugo, Sant Cugat del Valles (ES); Carlota Galindo Quintas, Sant Cugat del Valles (ES); Andrei Alexandru Dafinoiu, Sant Cugat del Valles (ES)

(73) Assignee: HEWLETT-PACKARD DEVELOPMENT COMPANY, L.P., Spring, TX (US)

(21) Appl. No.: 17/311,617

(22) PCT Filed: Jan. 30, 2019
(86) PCT No.: PCT/US2019/015893

§ 371 Date: Jun. 7, 2021

(51) Int. Cl. B41J 2/045; B41J 2/165

(52) U.S. Cl. CPC B41J 2/04573; B41J 2/04553; B41J 2/16508; B41J 2/16526; B41J 2/04566; B41J 2/0458

(57) ABSTRACT

There is disclosed a printhead control method, printhead controller and printer. The method may comprise determining whether ink drop variability is likely to occur based on a first time period in which a printhead is uncovered during a print action but before printing begins, and a second time period that is a minimum period for ink drop variability to occur when the printhead is uncovered. The method may further comprise setting a printhead firing frequency for the print action based on the determination.

### BACKGROUND

In thermal inkjet printing, nozzles may be fired by applying pulses of energy for example by using heater resistors. When an electric voltage is applied, electric current may flow through the heater resistor, heat the ink and cause it to eject from the nozzle.

In thermal inkjet printing, printhead carriages may have a symmetric carriage configuration, in which the printhead carriage may include printheads in a symmetric configuration allowing printing to be carried out with the same ink order layout on a print medium.

### BRIEF DESCRIPTION OF DRAWINGS

Examples will now be described, by way of non-limiting examples, with reference to the accompanying drawings, in which:

FIG. 1 is a flowchart of an example of a method of controlling a printhead; and

FIG. 2 is a flowchart of a further example of a method of controlling a printhead;

FIG. 3 is a simplified schematic of an example of a device for controlling a printhead;

FIG. 4 is a simplified schematic of a further example of a device for controlling a printhead;

FIG. 5 is a simplified schematic of an example of a printhead carriage having a symmetric configuration; and

FIG. 6 is a simplified schematic of an example of print locations on a print medium.

### DETAILED DESCRIPTION

In thermal inkjet printing, printer carriages may include a number of printheads. In some examples, print carriages may include four printheads, for printing the colours cyan, magenta, yellow and black (CMYK). In some examples, printhead carriages may have a symmetric carriage configuration, in which the printhead carriage may include printheads in a symmetric configuration allowing printing to be carried out with the same ink order layout on a print medium. In some examples printing may be carried out in both forward and reverse directions. With a symmetric carriage configuration, the printhead carriage may include eight printheads, with four printheads being used to print in each direction and each of the four being allocated to printing a colour. In some examples, all eight printheads may be used in a single direction. In some further examples, printing instructions may be split between two sets of printheads (operating in either the same or opposite directions) so as to reduce thermally associated issues at each nozzle, such as crusting. Print information may be split equally between the sets or apportioned between the sets as appropriate.

Printing may be carried out for example by moving the printhead carriage, in a print action, from an idle or docked position, across a print medium along a scan axis, before returning the carriage to its original position. In the docked position, printhead nozzles may be covered to preserve the printer ink. In some examples the print medium may be a sheet of paper and the idle position of the printer carriage may be on the left hand side relative to the direction of movement of the print medium, such that the printer carriage moves from the left hand side of the print medium across the print medium in a print action to the right hand side (which may be described as a forward movement), before returning to the starting position by moving from the right hand side of the print medium to the left hand side (which may be described as a reverse movement).

Printhead carriages may have a configuration such that printing is carried out in one direction only (the forward direction) or may be arranged to allow printing to be carried out in both forward and reverse directions. In some examples, the carriage may have a symmetric carriage configuration in which printing instructions may be divided between symmetric printheads, so as to reduce the number of firings from any one printhead.

Before performing a print action, printheads, and in particular printhead nozzles, may be positioned in an idle position in a service station wherein the printhead nozzles are covered so as to maintain the print material, for example print fluid, and to prevent the print fluid from drying out. Known issues include decap, decel and enrichment of the ink, which lead to inconsistent drops depending on a number of factors. Such issues may result from water evaporating rapidly from ink in uncapped nozzles, which may result in changes in the physical properties of the ink. Decap may involve dry ink blocking a nozzle and several fires may be required to unblock the nozzle. Decel may occur when part of the ink vehicle has evaporated which may cause ink drops to fall with a lower velocity onto the print medium. Dye enrichment may occur when ink pigment becomes more concentrated as the ink vehicle evaporates, leading to darker, more saturated, ink drops. All of these issues may be caused by drying of the ink due to exposure to air or due to heat/humidity variations and the effects may be different depending on the chemical composition of the ink. Additional drop firing may be used to reduce these issues before drops with the correct composition are produced.

These issues may impact image quality, and may lead to local colour variation issues, graininess and general ink drop variability. Ink drop variability may not occur immediately when a printhead nozzle is uncovered, but may in fact occur after a predictable and/or calculable period of time following uncovering of the printhead nozzle. In some cases, ink drop variability occurs after a time period long enough for a single print action to be carried out. However, in some situations ink drop variability may occur in a time period smaller than the time taken to carry out a single print action (for example the time taken to print a swath). In such a situation, it may be preferable to carry out preventative measures so as to reduce the likelihood of ink drop variability during the print action.

In the following examples devices and methods are disclosed for reducing ink drop variability in cases where ink drop variability is likely to occur in the time taken to carry out a single print action. These devices and methods may also be used to mitigate ink drop variability in cases where ink drop variability is likely to occur in a time period longer than the time period needed for a single print action to be carried out.

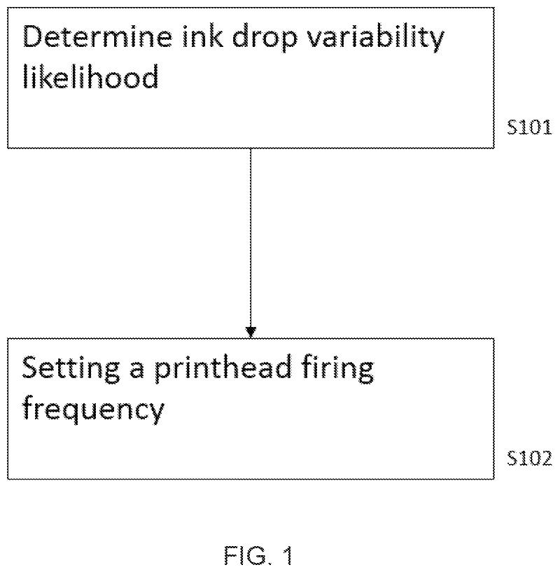

In some examples, as shown in FIG. 1, a printhead control method may comprise determining whether ink drop variability is likely to occur based on a first time period, T1, in which a printhead is uncovered during a print action but before printing begins, and a second time period, T2, that is a minimum period for ink drop variability to occur when the printhead is uncovered S101. The method may further comprise setting a printhead firing frequency for the print action based on the determination S102.

The first time period, T1, may begin when a printhead nozzle is uncovered at the start of a print action. This may for example be when the printhead moves away from the service station or idle position, in which position the printhead nozzles are covered. The first time period T1 may end when printing begins, for example when the printhead reaches an appropriate position and ink is deposited onto a print medium. The first time period T1 may depend on the position of the image or image part to be printed. For example, if the printhead is initially located on the first side of the print medium, the length of the first time period T1 will depend on where, along a scan axis on the print medium, printing should begin. If an image to be printed is located closer to the first side of the print medium, the first time period T1 will be shorter than if the image to be printed is located towards the second side of the print medium, opposite the first side. Therefore, the first time period T1 is dependent on the distance between the starting point of the printhead and the location on the print medium at which printing should begin. A further factor in determining the first time period may be the speed at which the printhead moves across the print medium from the initial position to the position where printing begins. The first time period T1 may be calculable based on where the image is to be printed and known values for the time taken for the printhead to move to that position and begin printing.

A printhead nozzle may be deemed uncovered when the nozzle or the printing ink is exposed to the ambient environment. A print action may for example be a single movement of a printhead across a print medium. Ink drop variability may be deemed likely to occur if the first time period T1 is determined to be greater than or equal to the second time period T2. The expression “likely” may mean that ink drop variability may be deemed to occur even if it does not actually occur owing to the variable nature of inks. The calculation of ink drop variability likelihood is used to mitigate ink drop variability issues. The printhead firing frequency may be increased or decreased based on whether ink drop variability is determined to be likely. For example, the printhead firing frequency may be increased if ink drop variability is deemed likely, to mitigate the variability and improve image quality.

Firing frequency of the ink drops may be controlled by means of printing masks. A masks may be considered as an array of numbers going from 1 to n, that are a number of printing swaths, that may describe how the drops are fired and distributed spatially over the print medium per printing swath. In symmetric configurations the firing frequency may be double if, instead of printing with eight printheads bi-directionally, the printing information is split such that four printheads print in a forward direction and four printheads in a reverse direction. Such an arrangement may allow printing to be carried out with the same ink order layout in each direction on a print medium.

In some examples, the determining is further based on whether an image to be printed exceeds a threshold contone level. A threshold contone level may represent a threshold level of shading or darkness. A contone level of an image may be determined based on a number of drops of ink placed on a print substrate. In some examples, a densitometer may be used, which is a tool that counts the total number or drops placed on a given region on a print pass. By evaluating the total number of drops, together with the saturation point of a colorant, it may be possible to calculate a threshold past which the defects are no longer visible. This may then be taken to be the threshold contone level. From knowing the number of ink drops per unit area (e.g. 600 dpi (dots per inch) cell), it may be possible to convert between drops and contone level.

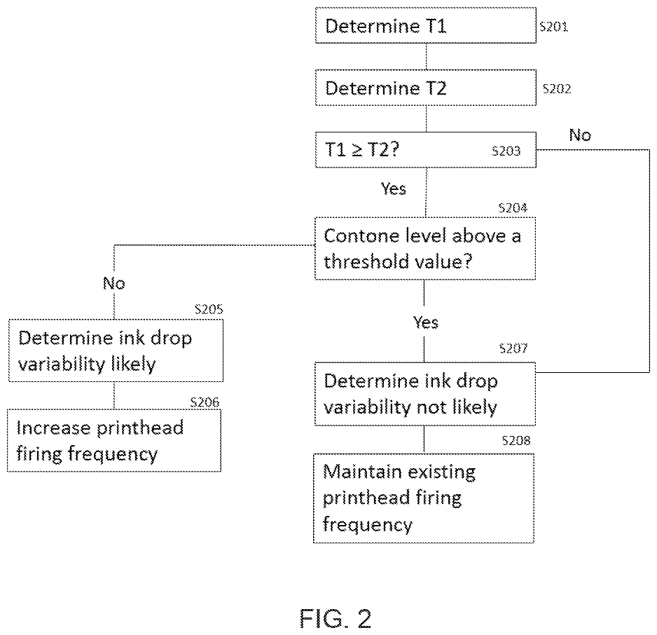

In some examples, as shown in FIG. 2, the first time period T1 is determined S201 and the second time period T2 is determined S202. The time periods may in some examples already be known. For example, known values for T1 and T2 may be stored in a memory (not shown). It may then be determined whether T1 is greater than or equal to T2 S203.

If T1 is greater than or equal to T2 at step S203 the process proceeds to step S204 where it is determined whether the contone level of the image lies above a threshold value. If the determination at S204 is “NO”, it is determined that ink drop variability is likely S205 and the printhead firing frequency is increased to compensate/mitigate ink drop variability S206. If the determination at S204 is “YES”, it is determined that ink drop variability is not likely S207 and the existing printhead firing frequency is maintained S208. Likewise at S203 if T1 is not greater than or equal to T2, and the determination is therefore “NO”, the process proceeds to step S207.

In some examples, the contone level is determined by a densitometer (not shown). In accordance with some examples ink drop variability may be deemed not likely above a threshold contone level. A threshold contone level may be set on the basis that ink drop variability above this threshold does not result in visible image quality deterioration. An image in accordance with the examples may include part of an image or a single line associated with an individual print movement. Contone may otherwise be described as continuous tone.

In some examples the first time period T1 may be determined based on a position of an image to be printed on a print medium. In accordance with some examples, the printhead travels from one side of the print medium to the other along a scan axis and the distance from the starting position along the scan axis to the print position may influence the length of the first time period T1. Further, in some examples the second time period T2 is determined based on at least one of the ink type used and ambient conditions around the printer. An example of the ink type used may be for example dye sub inks (dye sublimation printer inks). In some examples the ambient conditions include at least one of temperature and humidity of the air around the printhead nozzle. A higher temperature may affect the second time period, in that the ink drop variability may occur sooner due to faster drying out of the ink. Similarly, humidity of the air may affect the second time period, in that the ink drop variability may occur sooner when the air humidity drops, due to faster drying out of the ink.

In some examples the printhead control method may further include controlling spitting of the printhead based on the determination. In accordance with the examples printhead nozzles may be cleared using a method for spraying or spitting excess ink through the nozzles to reapply moisture and unblock any blocked nozzles.

In some examples there is provided a printhead control method for a printhead carriage having a symmetric carriage configuration. The printhead carriage having a symmetric carriage configuration may include a first printhead set and a second printhead set for splitting printing instructions between the printhead sets in order to reduce the number of firings for each printhead for the same print job. The printhead control method may further allow for printing in a forward direction and a reverse direction on a print medium.

The printhead control method may comprise performing, for each of the forward and reverse directions, the method as described above. In accordance with the examples the printhead control method is performed respectively for each of the forward and reverse directions, wherein the printheads may begin a forward or reverse direction movement from a service station at either side of the print medium. The service stations on either side of the print medium may include a primary and secondary spittoon, respectively. The service stations on either side of the print medium may allow the printheads to remain covered until a print action in the respective directions is initiated. In accordance with the examples the printhead control method may further comprise controlling spitting of the one or more printheads or of the printhead sets based on the determination.

When printing instructions are split between printhead sets, in the symmetric carriage configuration, the method described above, and the calculation of T1 and T2, may be performed for each printhead set, or even each printhead, in order to reduce the associated issues with uncovering the printheads (nozzles).

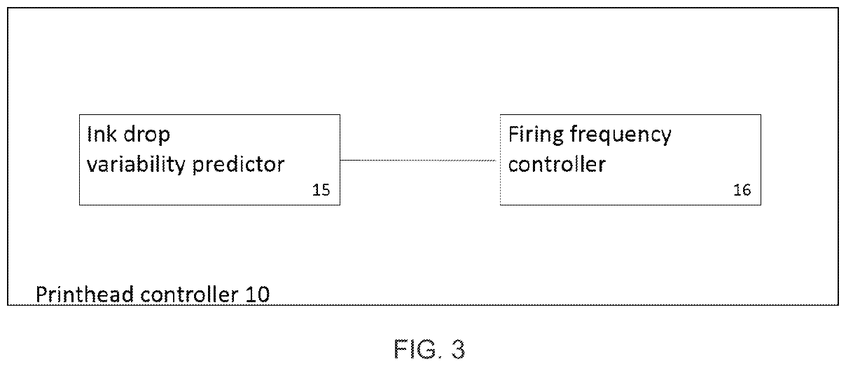

In accordance with some examples, as shown in FIG. 3, a printhead controller 10 may comprise an ink drop variability predictor 15 to predict a likelihood of variability based on the first time period T1 in which a printhead is uncovered during a print action before printing begins. A second time period T2 may be a minimum period for ink drop variability to occur when the printhead is uncovered. The printhead controller 10 may further comprise a firing frequency controller 16 to control a printhead firing frequency for the print action based on the prediction.

In some examples the printhead controller 10 may further comprise a densitometer for determining a contone level of an image to be printed wherein the prediction is further based on whether the image exceeds a threshold contone level. In some examples the printhead controller may be part of a printhead or may alternatively be separate to a printhead.

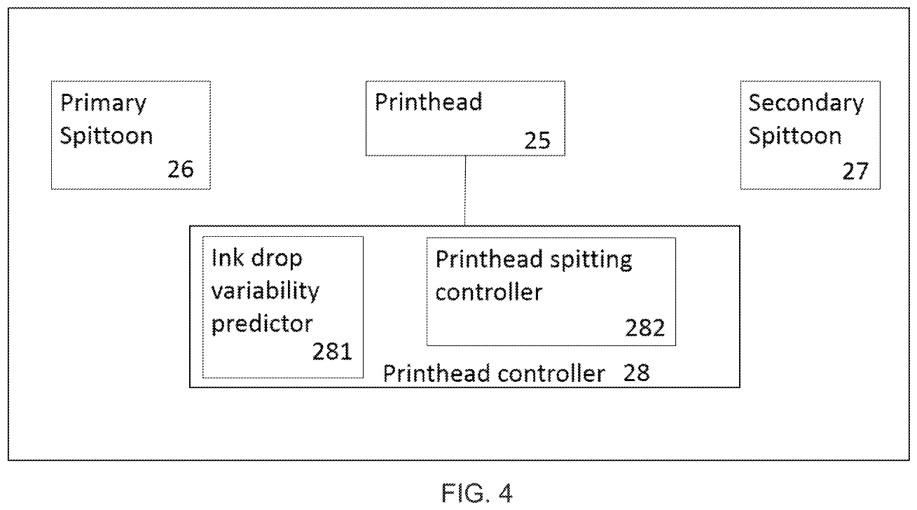

In accordance with some examples as shown in FIG. 4, a printer 20 may comprise a printhead 25 having a symmetric carriage configuration including first and second printhead sets for printing in a forward and reverse direction on a print medium. The printer 20 may further comprise a primary spittoon 26 positioned on a first side of a print medium transport path. The printer 20 may further comprise a secondary spittoon 27 positioned on a second side of the print medium transport path, opposite to the first side. The printer may further comprise a printhead controller 28 comprising an ink drop variability predictor 281 to predict a likelihood of ink drop variability based on a first time period T1 in which a printhead is uncovered during a print action before printing begins in either the forward or the reverse direction or in either the first or second printhead set and a second time period T2 that is a minimum period for ink drop variability to occur when the printhead is uncovered. The printhead controller 28 may further comprise a printhead spitting controller 282 to control printhead spitting based on the prediction.

In accordance with some examples the printer 20 may further comprise a densitometer (not shown) to determine a contone level of an image to be printed, wherein the prediction is further based on whether the image exceeds a threshold contone level. In some examples the second time period T2 is determined based on at least one of the ink type used and the ambient conditions around the printhead 25.

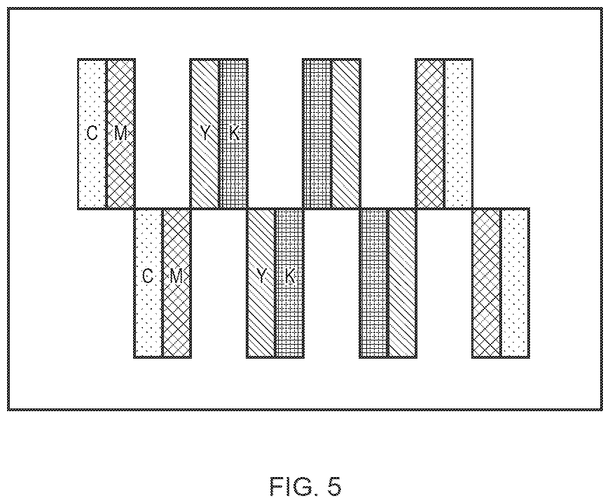

In some examples, as shown in FIG. 5, the printhead carriage may have a symmetric carriage configuration as shown in the figure. In such a configuration symmetrically positioned printheads for each colour may be positioned such that printing may be carried out by dividing the printing instructions between complimentary or symmetrically positioned printheads. Such an arrangement may allow printing to be carried out with the same ink order layout on a print medium. In some examples, the colours may be cyan, magenta, yellow and black, indicated by the letters CMYK respectively in the figure. (For the avoidance of doubt cyan is designated as C, magenta is designated as M, yellow is designated as Y and black is designated as K). In some examples, the carriage may include two printheads for each colour, in each direction, as depicted in FIG. 5. Symmetric carriage configuration may be implemented in both directions, as shown in the figure, such that printing instructions may be divided between printhead sets and directions. Printing instructions (which may correspond to an amount of ink printed) may be divided for example unevenly, such as 60% in a forward direction and 40% in a reverse direction (or 70/30, or evenly—50/50), with those divisions split between sets of printheads either evenly or unevenly. Dividing printing instructions in this way may allow the printhead firing frequency to be increased without any negative associated thermal issues occurring, such as crusting or kogation.

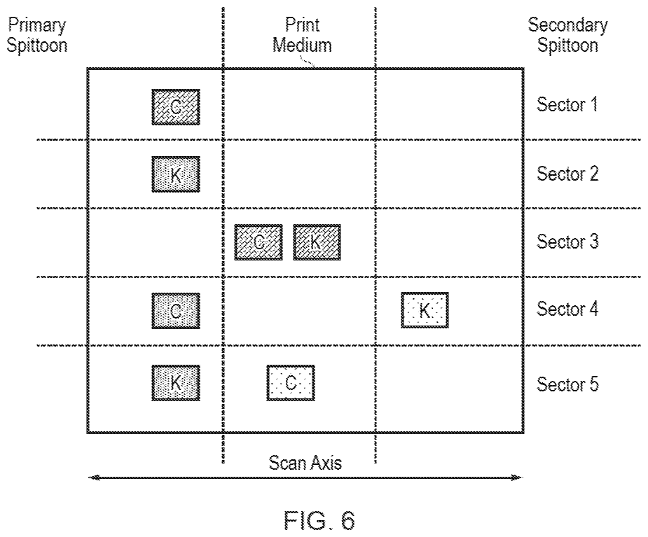

In some examples, as shown in FIG. 6, a print medium is shown wherein the direction of travel of the print medium is from the bottom of the figure to the top. That is to say, sector 1, as labelled in the figure, is printed first and sector 5 is printed last. In such an arrangement, as shown in FIG. 6, the scan axis extends from left to right in the figure. In this arrangement, a primary spittoon is located on the left and a secondary spittoon is located on the right. According to this arrangement, the forward printing direction extends from the left side of the print medium to the right and the reverse direction from the right side of the print medium to the left.

In accordance with the example shown, printing may begin with the image located in sector 1 in the figure, which is cyan in colour and has a contone level below the designated threshold. In the example shown the designated contone level threshold is 128. However, this is an example and the threshold contone level may be a number other than 128. In this example, given the proximity of the image to the start location of the printhead, the time period T1 is determined to be shorter than the time period T2. Therefore, it is determined that ink drop variability is not likely and the contone level of the image is in this situation not taken into account for the determination. (S203 in FIG. 2—“NO”). Therefore, the printhead firing frequency for this action is set to a regular (standard) frequency with no additional spit control.

Turning to the image for printing in sector 2, in this case the location of the image is such that T1 is less than T2 and the contone level of the image is greater than the threshold level. Therefore, the printhead firing frequency is set to a regular frequency with no additional spit control.

Turning to the images for printing in sector 3 both images are deemed to fall below the threshold contone level and the position of the images is such that T1 is equal to or greater than T2. As a representative example in FIG. 6, vertical dashed lines are placed at the point where T1=T2 in a forward direction and reverse direction, respectively. Therefore, it is determined that ink drop variability is likely for the images in sector 3 (S203—“YES” and S204—“NO” in FIG. 2) and the printhead firing frequency is increased for example to double the firing frequency of the regular firing frequency. This may be programmed for the printheads in either the forward or the reverse directions only, for example. The forward printing printheads may be programmed to spit in the primary spittoon and the reverse printheads may be programmed to spit in the secondary spittoon.

Turning to the images for printing in sector 4, the cyan image (labelled “C”) is deemed to have a contone level equal to or above the threshold value and the black image (labelled “K”) is deemed to have a contone level below the threshold value. The location of the cyan image is such that in the forward direction T1 is less than T2, but in the reverse direction T1 is equal to or greater than T2. The location of the black image is such that in the forward direction T1 is greater than or equal to T2, but in the reverse direction T1 is less than T2. Therefore, it is determined that, with respect to the cyan image, ink drop variability is not likely, such that the image quality will not be reduced, and the regular firing frequency is used. Regarding the black image, in the forward direction the printhead firing frequency is increased for example to double the firing frequency of the regular firing frequency, since ink drop variability is deemed likely, with forward printing printheads being programmed to spit in the primary spittoon. In the reverse direction, ink drop variability is deemed not likely and the regular firing frequency is used with no additional spit.

Turning to the images for printing in sector 5, the black image is deemed to have a contone level equal to or above the threshold value and the cyan image is deemed to have a contone level below the threshold value. Therefore, it is determined that, with respect to the black image, ink drop variability is not likely, such that the image quality will not be reduced, and the regular firing frequency is used. Regarding the cyan image, T1 is equal to or greater than T2 in both directions. Therefore, the printhead firing frequency is increased for example to double the firing frequency of the regular firing frequency in both directions. The forward printing printheads may be programmed to spit in the primary spittoon and the reverse printheads may be programmed to spit in the secondary spittoon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A printhead control method comprising:
determining whether ink drop variability is likely to occur based on a first time period, T1, in which a printhead is uncovered during a print action before printing begins, and a second time period, T2, that is a minimum period for ink drop variability to occur when the printhead is uncovered; and
setting a printhead firing frequency for the print action based on the determination.

2. The printhead control method according to claim 1, wherein the determining is further based on whether an image to be printed exceeds a threshold contone level.

3. The printhead control method according to claim 2, wherein the contone level is determined by a densitometer.

4. The printhead control method according to claim 1, wherein the first time period, T1, is determined based on a position of an image to be printed on a print medium.

5. The printhead control method according to claim 1, wherein the second time period, T2, is determined based on at least one of ink type and ambient conditions.

6. The printhead control method according to claim 5, wherein the ambient conditions include at least one of temperature and humidity.

7. The printhead control method according to claim 1, further comprising:
controlling spitting of a printhead based on the determination.

8. A printhead control method for a printhead carriage having a carriage configuration including a forward printhead set and a reverse printhead set for printing in a forward and a reverse direction, respectively, the printhead control method comprising:
performing, for each of the forward and reverse printhead sets, the printhead control method according to claim 1.

9. A printhead control method for a printhead carriage having a symmetric carriage configuration including a first printhead set and a second printhead set for dividing printing instructions between the first and second printhead sets, the printhead control method comprising:
performing, for each of the first and second printhead sets, the printhead control method according to claim 1.

10. A printhead controller comprising:
an ink drop variability predictor to predict a likelihood of ink drop variability based on a first time period, T1, in which a printhead is uncovered during a print action before printing begins, and a second time period, T2, that is a minimum period for ink drop variability to occur when the printhead is uncovered; and
a firing frequency controller to control a printhead firing frequency for the print action based on the prediction.

11. The printhead controller according to claim 10, further comprising:
a densitometer to determine a contone level of an image to be printed, wherein
the prediction is further based on whether the image exceeds a threshold contone level.

12. A printhead comprising the printhead controller according to claim 10.

13. A printer comprising:
a printhead having a symmetric carriage configuration including first and second printhead sets for printing in a forward and reverse direction on a print medium;
a primary spittoon positioned on a first side of a print medium transport path;
a secondary spittoon positioned on a second side of the print medium transport path, opposite the first side;
a printhead controller comprising:
an ink drop variability predictor to predict a likelihood of ink drop variability based on a first time period, T1, in which a printhead is uncovered during a print action before printing begins in either the first or second printhead set, and a second time period, T2, that is a minimum period for ink drop variability to occur when the printhead is uncovered; and
a printhead spitting controller to control printhead spitting based on the prediction.

14. The printer according to claim 13, further comprising:
a densitometer to determine a contone level of an image to be printed, wherein
the prediction is further based on whether the image exceeds a threshold contone level.

15. The printer according to claim 13, wherein the second time period, T2, is determined based on at least one of ink type and ambient conditions.
